(19) United States
(12) Patent Application Publication
(10) Pub. No.: US 2014/0275396 A1
(43) Pub. Date: Sep. 18, 2014

(54) LOW GLOSS ACRYLIC COATINGS CONTAINING ISOPHTHALIC POLYESTER COMPOSITIONS

(71) Applicant: PPG INDUSTRIES OHIO, INC., Cleveland, OH (US)

(72) Inventors: Anthony M. Chasser, Allison Park, PA (US); Dan M. Bratys, SR., Willoughby, OH (US); John H. Young, Rocky River, OH (US)

(21) Appl. No.: 13/832,723

(22) Filed: Mar. 15, 2013

(51) Int. Cl. C09D 133/14; C09D 133/06; C09D 167/02

(52) U.S. Cl. CPC C09D 133/14; C09D 167/02; C09D 133/06
USPC 524/513

(57) ABSTRACT

Low-gloss coatings including acrylic polymer and isophthalic polyester compositions are disclosed. The presence of separate acrylic polymer and isophthalic polyester phases in the coating provides a low-gloss finish while maintaining properties such as hardness and mar resistance of the coatings.

### FIELD OF THE INVENTION

The present invention relates to coatings containing isophthalic polyester compositions, and more particularly relates to low gloss acrylic coatings comprising such isophthalic polyester compositions.

### BACKGROUND OF THE INVENTION

Low gloss coatings have been produced by additions of silica flattening particles. However, coating compositions containing such particles tend to settle and need to be continuously stirred to provide uniform amounts of silica to the film coating. Silica particles also tend to abrade spray equipment and the silica particles are ground down by recirculation pumps typically used at automotive production facilities. This creates reproducibility problems in the coatings because the ground-down silica particles have smaller sizes and therefore do not provide the same levels of gloss reduction.

### SUMMARY OF THE INVENTION

An aspect of the invention provides a low-gloss coating composition comprising acrylic resin, and an isophthalic polyester composition, wherein when the coating composition is cured it has a 20° gloss of less than 80 gloss units.

Another aspect of the invention provides a cured coating comprising an acrylic polymer, and an isophthalic polyester, wherein the cured coating has a 20° gloss of less than 80 gloss units.

### DETAILED DESCRIPTION OF EMBODIMENTS OF THE INVENTION

The present invention provides low gloss coatings comprising isophthalic polyester and acrylic components. As used herein, the term “low gloss” refers to coatings that do not have a high gloss finish but rather have a flat, matt, eggshell, satin or semi-gloss finish. The degree of gloss may be measured in accordance with standard procedures known in the art, e.g., by a commercially available gloss meter operating at a selected angle of reflection. In certain embodiments, the low-gloss coatings of the present invention have a 20° gloss of less than 80 gloss units, for example, less than 60 or 40 gloss units. In certain embodiments, the 20° gloss may be less than 20 gloss units, or less than 15 gloss units. For example, a low-gloss coating in accordance with an embodiment of the present invention may have a 20° gloss of from 1 to 12 gloss units. In certain embodiments, the 20° gloss may be less than 10 or 5 gloss units. While not intending to be bound by any particular theory, the low gloss properties of the present coatings may result from the formation of separate phases of isophthalic polyester and acrylic polymer in the cured coating films that have different refractive indices that tend to scatter incident light or otherwise interact to reduce the gloss of the coatings.

In accordance with embodiments of the invention, the low gloss coating compositions comprise isophthalic polyester compositions in typical amounts of from 20 to 80 weight percent of the coating composition based on the total weight of the isophthalic polyester and acrylic components, for example, from 30 to 70 weight percent, or from 40 to 60 weight percent.

The acrylic component of the low gloss coating compositions may typically comprise from 20 to 80 weight percent of the coating composition based on the total weight of the isophthalic polyester and acrylic components, for example, from 30 to 70 weight percent, or from 40 to 60 weight percent.

The isophthalic polyester compositions used in accordance with embodiments of the present invention may comprise, but are not limited to, a branched polyester prepared as the reaction product of a polyacid comprising at least 90 mole percent isophthalic acid, including its ester and/or anhydride, and a polyol comprising a tri- or higher-functional polyol. The branched polyester polymer may be prepared from a polyacid. “Polyacid” and like terms, as used herein, refers to a compound having two or more acid groups and includes the ester and/or anhydride of the acid.

In certain embodiments, the polyacid utilized comprises at least at least 90 mole percent, such as at least 95 mole percent, and in other embodiments comprises greater than 95 mole percent, such as 100 mole percent, isophthalic acid.

In certain embodiments, one or more additional acids can also be used. Such acids can include, for example, other polyacids, monoacids, fatty acids, the esters and/or anhydrides of any of these acids and/or combinations thereof.

The branched polyester polymer may be also prepared from a polyol. “Polyol” and like terms, as used herein, refers to a compound having two or more hydroxyl groups. Polyols can also be chosen to contribute hardness to the branched polyester polymer. Suitable polyols for use in the invention may be any polyols known for making polyesters. Examples include, but are not limited to, alkylene glycols, such as ethylene glycol, propylene glycol, diethylene glycol, dipropylene glycol, triethylene glycol, tripropylene glycol, hexylene glycol, polyethylene glycol, polypropylene glycol and neopentyl glycol; hydrogenated bisphenol A; cyclohexanediol; propanediols including 1,2-propanediol, 1,3-propanediol, butyl ethyl propanediol, 2-methyl-1,3-propanediol, and 2-ethyl-2-butyl-1,3-propanediol; butanediols including 1,4-butanediol, 1,3-butanediol, and 2-ethyl-1,4-butanediol; pentanediols including trimethyl pentanediol and 2-methylpentanediol; 2,2,4-trimethyl-1,3-pentanediol, cyclohexanedimethanol; hexanediols including 1,6-hexanediol; 2-ethyl-1,3-hexanediol, caprolactonediol (for example, the reaction product of epsilon-caprolactone and ethylene glycol); hydroxy-alkylated bisphenols; polyether glycols, for example, poly(oxytetramethylene)glycol; trimethylol propane, di-trimethylol propane, pentaerythritol, di-pentaerythritol, trimethylol ethane, trimethylol butane, dimethylol cyclohexane, glycerol, tris(2-hydroxyethyl)isocyanurate and the like.

During and/or after its formation, the branched polyester of the present invention can be dissolved or dispersed in a single solvent or a mixture of solvents. Any solvent that is typically used during the formation of polyesters may be used, and these will be well known to the person skilled in the art. Typical examples include water, organic solvent(s), and/or mixtures thereof. Suitable organic solvents include but are not limited to glycols, glycol ether alcohols, alcohols, ketones such as: methyl ethyl ketone, methyl isobutyl ketone, and mixtures thereof; aromatic hydrocarbons, such as xylene and toluene and those available from Exxon-Mobil Chemical Company under the SOLVESSO trade name; acetates including glycol ether acetates, ethyl acetate, n-butyl acetate, n-hexyl acetate, and mixtures thereof; mineral spirits, naphthas and/or mixtures thereof. “Acetates” include the glycol ether acetates. In certain embodiments, the solvent is a non-aqueous solvent. “Non-aqueous solvent” and like terms means that less than 50% of the solvent is water. For example, less than 10%, or even less than 5% or 2%, of the solvent can be water. It will be understood that mixtures of solvents, including or excluding water in an amount of less than 50%, can constitute a “non-aqueous solvent”.

In certain embodiments, the amount of solvent added to disperse or dissolve the branched polyester is such that the branched polyester is between about 30 and 80 weight percent based on resin solids (i.e. where the solvent is between 20 and 70 percent of the total weight of the branched polyester and solvent). In certain embodiments, the amount of solvent added to disperse or dissolve the branched polyester is such that the branched polyester is between about 50 and 70 weight percent, such as 60 weight percent, based on resin solids.

In certain embodiments, the branched polyesters of the invention may have a weight average M_{W} as low as 600, or can have an M_{W} greater than 1000, such as greater than 5000, greater than 10,000, greater than 15,000, greater than 25,000, or greater than 50,000, as determined by gel permeation chromatography using a polystyrene standard. Weight average molecular weights between 2,000 and 6,000 are particularly suitable in some embodiments.

In addition to the molecular weight described above, the branched polyesters of the present invention can also have a relatively high functionality; in some cases the functionality is higher than would be expected for conventional polyesters having such molecular weights. The average functionality of the polyester can be 2.0 or greater, such as 2.5 or greater, 3.0 or greater, or even higher. “Average functionality” as used herein refers to the average number of functional groups on the branched polyester. The functionality of the branched polyester is measured by the number of hydroxyl groups that remain unreacted in the branched polyester, and not by the unreacted unsaturation. In certain embodiments, the hydroxyl value of the branched polyesters of the present invention can be from 10 to 500 mg KOH/gm, such as 30 to 250 mg KOH/gm.

In certain embodiments, the branched polyester comprises the reaction product of reactants comprising, based on the total weight of the polyester, 5 to 50 weight percent of 2-methyl-1,3-propane diol, 5 to 60 weight percent neopentyl glycol, 5 to 70 weight percent isophthalic acid, and 5 to 40 weight percent trimethylolpropane, where the mole percent ratio of diol and glycol components are above 51% and the mole ratio of alcohol equivalents to carboxyl equivalents is between 1.03 and 1.15. The weight average molecular weight, as determined by gel permeation chromatography using a polystyrene standard, is preferably between about 2,000 and 6,000. In certain of these embodiments, the branched polyester is reduced to between 30 and 80 percent resin solids (i.e. the solvent comprises between 20 and 70 percent, by weight, of the total weight of the branched polyester) by addition of a solvent or a mixture of solvents.

In certain embodiments, the branched polyester comprises the reaction product of reactants comprising, based on the total weight of the reactants: (a) 5-70 weight percent dicarboxylic acid, wherein at least 90 mole percent of the dicarboxylic acid comprises isophthalic acid; and (b) 5-50 weight percent polyol, wherein 1-99 weight percent of the polyol comprises an asymmetric diol and wherein the remainder of the polyol comprises a tri- or higher-functional polyol. In certain of these embodiments, the branched polyester is reduced to between 30 and 80 percent resin solids by addition of a solvent or a mixture of solvents.

In certain embodiments, the branched polyester comprises the reaction product of reactants comprising, based on the total weight of the reactants: (a) 5-70% dicarboxylic acid, wherein at least 90 mole percent of the dicarboxylic acid comprises isophthalic acid; (b) 5-50% polyol, wherein 1-99% of the polyol comprises an asymmetric diol and wherein the remainder of the polyol comprises a tri- or higher-functional polyol; and (c) 1-30% of a monoacid. In certain related embodiments, the monacid comprises benzoic acid. In certain of these embodiments, the branched polyester is reduced to between 30 and 80 weight percent of the total weight of the branched polyester by addition of a solvent or a mixture of solvents (i.e. wherein the solvent and/or mixture of solvents comprises between 20 and 70 weight percent of the total weight of the polyester and solvents).

The acrylic component of the coating compositions in accordance with embodiments of the present invention are acrylic polymers comprising copolymers of one or more alkyl esters of acrylic acid or methacrylic acid optionally together with one or more other polymerizable ethylenically unsaturated monomers. Suitable alkyl esters of acrylic acid or methacrylic acid include aliphatic alkyl esters containing from 1-30, preferably 4-18 carbon atoms in the alkyl group. Examples include methyl methacrylate, ethyl methacrylate, butyl methacrylate, ethyl acrylate, butyl acrylate, 2-ethylhexyl acrylate and 2-ethylhexyl methacrylate. Suitable other copolymerizable ethylenically unsaturated monomers include vinyl aromatic compounds such as styrene which is preferred and vinyl toluene; nitrites such acrylonitrile and methacrylonitrile; vinyl and vinylidene halides such as vinyl chloride and vinylidene fluoride and vinyl esters such as vinyl acetate.

Hydroxyl functional groups are most often incorporated into the polymer by using functional monomers such as hydroxyalkyl acrylates and methacrylates, having 2 to 4 carbon atoms in the hydroxy-alkyl group including hydroxyethyl acrylate, hydroxyethyl methacrylate, hydroxypropyl acrylate, hydroxypropyl methacrylate, 4-hydroxybutyl acrylate, 4-hydroxybutyl methacrylate and the like. Also hydroxy functional adducts of caprolactone and hydroxyalkyl acrylates and methacrylates. Mixtures of these hydroxyalkyl functional monomers may also be used. The acrylic polyol polymer can be prepared by solution polymerization techniques. In conducting the reaction, the monomers are heated, typically in the presence of a free radical initiator and optionally a chain transfer agent, in an organic solvent in which the ingredients as well as the resultant polymer product are compatible. Typically, the organic solvent is charged to a reaction vessel and heated to reflux, optionally under an inert atmosphere. The monomers and other free radical initiator are added slowly to the refluxing reaction mixture. After the addition is complete, some additional initiator may be added and the reaction mixture held at an elevated temperature to complete the reaction.

The acrylic polymer used in the film-forming composition typically has a weight average molecular weight of about 2,000 to about 25,000, preferably 3,000 to 10,000 as determined by gel permeation chromatography using a polystyrene standard. The hydroxyl equivalent weight of the polymer is generally about 200 to about 800, preferably about 300 to about 500.

In certain embodiments, the coating compositions may contain crosslinkers typically used in coating formulations. The crosslinker, or crosslinking resin or agent, can be any suitable crosslinker or crosslinking resin known in the art, and will be chosen to be reactive with the functional group or groups on the polyester. Non-limiting examples of suitable crosslinkers include phenolic resins, amino resins, epoxy resins, isocyanate resins, beta-hydroxy (alkyl) amide resins, alkylated carbamate resins, polyacids, anhydrides, organometallic acid-functional materials, polyamines, polyamides, aminoplasts and mixtures thereof.

Suitable isocyanates include multifunctional isocyanates. Examples of multifunctional polyisocyanates include aliphatic diisocyanates like hexamethylene diisocyanate and isophorone diisocyanate, and aromatic diisocyanates like toluene diisocyanate and 4,4′-diphenylmethane diisocyanate. The polyisocyanates can be blocked or unblocked. Examples of other suitable polyisocyanates include isocyanurate trimers, allophanates, and uretdiones of diisocyanates and polycarbodiimides such as those disclosed in U.S. patent application Ser. No. 12/056,304 filed Mar. 27, 2008, incorporated by reference in pertinent part herein. Suitable polyisocyanates are well known in the art and widely available commercially. For example, suitable polyisocyanates are disclosed in U.S. Pat. No. 6,316,119 at columns 6, lines 19-36, incorporated by reference herein. Examples of commercially available polyisocyanates include DESMODUR VP2078 and DESMODUR N3390, which are sold by Bayer Corporation, and TOLONATE HDT90, which is sold by Perstorp.

Suitable aminoplasts include condensates of amines and/or amides with aldehyde. For example, the condensate of melamine with formaldehyde is a suitable aminoplast. Suitable aminoplasts are well known in the art. A suitable aminoplast is disclosed, for example, in U.S. Pat. No. 6,316,119 at column 5, lines 45-55, incorporated by reference herein.

In preparing the present coatings, the branched polyester and the crosslinker can be dissolved or dispersed in a single solvent or a mixture of solvents. Any solvent that will enable the formulation to be coated on a substrate may be used, and these will be well known to the person skilled in the art. Suitable organic solvents include but are not limited to glycols, glycol ether alcohols, alcohols, ketones such as: methyl ethyl ketone, methyl isobutyl ketone, and mixtures thereof; aromatic hydrocarbons, such as xylene and toluene and those available from Exxon-Mobil Chemical Company under the SOLVESSO trade name; acetates including glycol ether acetates, ethyl acetate, n-butyl acetate, n-hexyl acetate, and mixtures thereof; mineral spirits, naphthas and/or mixtures thereof. “Acetates” include the glycol ether acetates. In certain embodiments, the solvent is a non-aqueous solvent. “Non-aqueous solvent” and like terms means that less than 50 weight percent of the solvent is water, based on the total solvent weight. For example, less than 10 weight percent, or even less than 5 weight percent or 2 weight percent, of the solvent can be water. It will be understood that mixtures of solvents, including or excluding water in an amount of less than 50 weight percent, based on the total solvent weight, can constitute a “non-aqueous solvent”.

In certain embodiments, the coatings of the present invention further comprise a curing catalyst. Any curing catalyst typically used to catalyze crosslinking reactions between polyester resins and crosslinkers, such as phenolic resins, may be used, and there are no particular limitations on the catalyst. Examples of such a curing catalyst include phosphoric acid, alkyl aryl sulphonic acid, dodecyl benzene sulphonic acid, dinonyl naphthalene sulphonic acid, and dinonyl naphthalene disulphonic acid.

If desired, the coating compositions can comprise other optional materials well known in the art of formulating coatings in any of the components, such as colorants, plasticizers, abrasion resistant particles, anti-oxidants, hindered amine light stabilizers, UV light absorbers and stabilizers, surfactants, flow control agents, thixotropic agents, fillers, organic cosolvents, reactive diluents, catalysts, grind vehicles, and other customary auxiliaries.

It will be appreciated that the polyester of the present invention and crosslinker therefor can form all or part of the film-forming resin of the coating. In certain embodiments, one or more additional film-forming resins are also used in the coating. For example, the coating compositions can comprise any of a variety of thermoplastic and/or thermosetting compositions known in the art. The coating compositions may be water-based or solvent-based liquid compositions, or alternatively, may be in solid particulate form, i.e., a powder coating.

Thermosetting or curable coating compositions may also comprise additional film-forming polymers or resins having functional groups that are reactive with either themselves or a crosslinking agent. The additional film-forming resin can be selected from, for example, polyester polymers, polyurethane polymers, polyamide polymers, polyether polymers, polysiloxane polymers, copolymers thereof, and mixtures thereof. Generally, these polymers can be any polymers of these types made by any method known to those skilled in the art. Such polymers may be solvent-borne or water-dispersible, emulsifiable, or of limited water solubility. The functional groups on the film-forming resin may be selected from any of a variety of reactive functional groups including, for example, carboxylic acid groups, amine groups, epoxide groups, hydroxyl groups, thiol groups, carbamate groups, amide groups, urea groups, isocyanate groups (including blocked isocyanate groups) mercaptan groups, and combinations thereof. Appropriate mixtures of film-forming resins may also be used in the preparation of the present coating compositions.

In certain embodiments, the coating compositions may include minor amounts of flattening agents such as silica-based flatteners. For example, the compositions may comprise up to 5 weight percent silica-based flatteners, or up to 3 or 2 weight percent silica-based flatteners, based on the total solids content of the coating compositions. In one embodiment, the silica-based flattener comprises silica-based material or a combination of silica-based materials that lower the gloss of the coatings when cured. For example, in one embodiment, the silica-based flattener comprises any commercially available silica including, but not limited to, thermally derived silicas, precipitated silicas, surface treated silicas, wax treated amorphous silicas, organically treated amorphous silicas, pyrogenic surface modified silicas, hydrophobic silicas or combinations thereof. In one exemplary embodiment, the silica-based flattener comprises a pyrogenic surface modified silica.

In certain embodiments, the coating compositions are substantially free of silica-based flatteners. As used herein, the term “substantially free”, when referring to the presence of silica-based flatteners, means that such flatteners are not purposefully added to the coating compositions, but may be present in trace amounts or as impurities.

The following examples are intended to illustrate various aspects of the invention, and are not intended to limit the scope of the invention.

### Examples

Coating compositions were formulated as listed in Table 1.

TABLE 1

| | Sample 1 | Sample 2 | Sample 3 | Sample 4 |
|---|---|---|---|---|
| Aromatic 100¹ | 20 g | 20 g | 20 g | 20 g |
| Butanol¹ | 2 g | 2 g | 2 g | 2 g |
| Tridecyl alcohol¹ | 2 g | 2 g | 2 g | 2 g |
| Butyl carbitol¹ | 2 g | 2 g | 2 g | 2 g |
| Eversorb 76² | 1 g | 1 g | 1 g | 1 g |
| Eversorb 292² | 0.5 g | 0.5 g | 0.5 g | 0.5 g |
| RC 39 3333³ | 14 g | 14 g | — | 85 g |
| RP 77 4251⁴ | 31 g | 31 g | 85 g | — |
| Cymel 202⁵ | 19 g | 19 g | 19 g | 19 g |
| Cymel 1156⁵ | 4 g | 4 g | 4 g | 4 g |
| Nacure 5528⁶ | 2 g | 2 g | 2 g | 2 g |
| BYK 378⁷ | 0.1 g | 0.1 g | 0.1 g | 0.1 g |
| Silica OK 412⁸ | — | 2 g | — | — |
| 11-DLW-129⁹ | 40 g | 40 g | — | — |

¹Aromatic 100, Butanol, Butyl carbitol and Tridecyl alcohol are standard commercially available solvents.
²Eversorb 76 and 292 are UV absorber ingredients commercially available from Everlight Chemical Industrial Corp.
³RC 39 3333 is a standard acrylic functional polymer commercially available from PPG Industries, Inc.
⁴RP-77-4251 is a hydroxy functional polyester resin with isophthalic acid as the only diacid material in ~50% concentration.
⁵Cymel 202 and 1156 are melamine crosslinkers commercially available from Cytec Industries.
⁶Nacure 5528 is a sulfonic acid based catalyst commercially available from King Industries.
⁷BYK 378 is a silicone surface additive commercially available from BYK Chemie.
⁸OK 412 is a standard silica flattening agent available from Acematt.
⁹11-DLW-129 is a hydroxy functional acrylic resin from PPG Industries with a basic composition of 50% HEMA, 30% MMA and 20% styrene.

The coating compositions listed in Table 1 were applied to electrocoated ED 6060 panels commercially available from PPG Industries Inc. by conventional hand spray techniques technique and cured. The cured coatings had dry film thicknesses of about 2 mil. The coating Samples 1-4 were tested for gloss properties, hardness, and mar abrasion resistance, along with a low-gloss coating containing relatively large amounts of silica commercially available from PPG Industries, Inc. under the designation CeramiClear, which is labeled as Sample 5. The results are shown in Table 2.

TABLE 2

| | 20° gloss | FMH | 20° gloss | | | | |
|---|---|---|---|---|---|---|---|
| | with 275° F./ | At 300° F./ | with 300° F./ | 3 Micron | 9 Micron | 4,000 | MEK |
| | 30 min. | 30 min. | 30 min. | mar | mar | hours | double |
| | bake | bake | bake | abrasion | abrasion | WOM | rubs |
| Sample 1 | 12 | 152 | 11 | 10 | 8 | 100% | +100 |
| | | | | | | retention | |
| Sample 2 | 2 | 153 | 2 | 2 | 2 | 100% | +100 |
| | | | | | | retention | |
| Sample 3 | 95 | 200 | 96 | 40 | 11 | 100% | +100 |
| | | | | | | retention | |
| Sample 4 | 88 | 89 | 89 | 36 | 7 | 85% | +100 |
| | | | | | | retention | |
| Sample 5 | 2 | 167 | 1 | 2 | 2 | 95% | +100 |
| | | | | | | retention | |

In Table 2, the 20° gloss/haze measurements are performed using a standard Byk Gardner Gloss Haze Meter. The Fischer MicroHardness (FMH) values are measured by a standard HM2000 Fischer MicroHardness tester. The 3 and 9 Micron mar abrasion values are measured using a standard Atlas Tester in which a 2×2 inch piece of 3M abrasive paper backed with felt cloth is clamped to an acrylic finger on the arm of the instrument, and a set of 10 double rubs (unless indicated otherwise) is run on each panel. The panel is then rinsed with cool tap water and dried. Scratch resistance is expressed as the percentage of the 20° gloss that was retained after the surface was scratched by the scratch tester. The weather-o-meter (WOM) values are measured by a standard SAE J2527 procedure. The methylethylketone (MEK) double rub values are measured by a standard solvent rub testing method (STM) know in the art.

Sample 1 comprising an acrylic polymer phase and an isophthalic polyester phase demonstrates that low gloss is obtained with no flattening silica, compared to high-gloss Samples 3 and 4 containing either the acrylic polymer or the isophthalic polyester with no phase separation occurring and no silica flattener. Samples 3 and 4 demonstrate that when the acrylic and isophthalic polyester components are not present in combination with each other the gloss is very high. The results shown in Table 2 further demonstrate that the gloss is consistent with different baking conditions. Sample 2 comprising both the acrylic polymer and the isophthalic polyester demonstrates that the low gloss can be lowered even further with a minor amount of a silica flattening agent, well below the levels required to produce matt finishes in conventional clearcoats. Table 2 also shows that the coatings are durable, solvent resistant and scratch resistant.

For purposes of this detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A low-gloss coating composition comprising:
acrylic resin; and
an isophthalic polyester composition, wherein when the coating composition is cured it has a 20° gloss of less than 80 gloss units.

2. The low-gloss coating composition of claim 1, wherein the acrylic resin comprises from 20 to 80 weight percent and the isophthalic polyester composition comprises from 20 to 80 weight percent, based on the total weight of the acrylic resin and isophthalic polyester.

3. The low-gloss coating composition of claim 1, wherein the acrylic resin comprises from 40 to 60 weight percent and the isophthalic polyester composition comprises from 40 to 60 weight percent, based on the total weight of the acrylic resin and isophthalic polyester.

4. The low-gloss coating composition of claim 1, further comprising a crosslinker.

5. The low-gloss coating composition of claim 1, wherein the coating composition is substantially free of silica-based flatteners.

6. The low-gloss coating composition of claim 1, wherein the coating composition comprises up to 5 weight percent of a silica-based flattener based on the total solids content of the coating composition.

7. The low-gloss coating composition of claim 6, wherein the silica-based flattener comprises less than 3 weight percent.

8. The low-gloss coating composition of claim 1, wherein the cured coating composition has a 20° gloss of less than 40 gloss units.

9. The low-gloss coating composition of claim 1, wherein the cured coating composition has a 20° gloss of less than 12 gloss units.

10. The low-gloss coating composition of claim 1, wherein the coating composition comprises a clearcoat.

11. A cured coating comprising:
an acrylic polymer; and
an isophthalic polyester, wherein the cured coating has a 20° gloss of less than 80 gloss units.

12. The cured coating of claim 11, wherein the acrylic resin comprises from 20 to 80 weight percent and the isophthalic polyester composition comprises from 20 to 80 weight percent, based on the total weight of the acrylic resin and isophthalic polyester.

13. The cured coating of claim 11, wherein the acrylic resin comprises from 40 to 60 weight percent and the isophthalic polyester composition comprises from 40 to 60 weight percent, based on the total weight of the acrylic resin and isophthalic polyester.

14. The cured coating of claim 11, further comprising a crosslinker.

15. The cured coating of claim 11, wherein the coating composition is substantially free of silica-based flatteners.

16. The cured coating of claim 11, wherein the coating composition comprises up to 5 weight percent of a silica-based flattener based on the total solids content of the coating composition.

17. The cured coating of claim 16, wherein the silica-based flattener comprises less than 3 weight percent.

18. The cured coating of claim 11, wherein the cured coating has a 20° gloss of less than 40 gloss units.

19. The cured coating of claim 11, wherein the cured coating has a 20° gloss of less than 12 gloss units.

20. The cured coating of claim 11, wherein the coating composition comprises a clearcoat.
